(19) United States
(12) Patent Application Publication
(10) Pub. No.: US 2005/0081986 A1
(43) Pub. Date: Apr. 21, 2005

(54) Die bonding apparatus and method for bonding semiconductor chip using the same

(76) Inventors: Heung-Kyu Kwon, Seongnam-si (KR); Se-Nyun Kim, Cheonan-si (KR); Ki-Myung Yoon, Cheonan-si (KR)

Correspondence Address: HARNESS, DICKEY & PIERCE, P.L.C., P.O. BOX 8910, RESTON, VA, 20195, US

(21) Appl. No.: 10/885,768

(22) Filed: Jul. 8, 2004

(30) Foreign Application Priority Data
Oct. 15, 2003 (KR) 2003-71932

(51) Int. Cl. C09J 1/00; B32B 31/00

(52) U.S. Cl. 156/249; 156/538; 156/250

(57) ABSTRACT

A die bonding apparatus may include a bond head providing a heating function. The bond head may include a die collet for picking up a semiconductor chip when performing a die bonding process. The die collet may heat the semiconductor chip by using heat transmitted from the bond head when picking up the chip. The die collet may also provide a heating function for heating the chip.

### BACKGROUND OF THE INVENTION

This application claims priority of Korean Patent Application No. 2003-71932, filed on Oct. 15, 2003 in the Korean Intellectual Property Office, the disclosure of which is incorporated herein in its entirety by reference.

1. Field of the Invention

The present invention relates, in general, to a die bonding apparatus and a method for bonding a semiconductor chip using the same.

2. Description of the Prior Art

There is a growing desire for portable electronic products. To meet this desire, it is necessary to make the components of such products more compact, thinner and/or lighter.

In order to make electronic products more compact, thinner and/or lighter, it may be necessary to use techniques for reducing the sizes of the components, for example, a system on chip (SOC) technique where a number of elements are built in one chip or a system in package (SIP) technique where a number of elements are integrated in a package, etc.

In the SIP technique, a plurality of silicon chips may be mounted vertically or horizontally in a package, and this technique developed from a conventional multi-chip module (MCM). In conventional MCM, horizontal mounting method has been used when integrating a plurality of chips into a same package. On the other hand, a method of stacking a plurality of chips vertically may be applied in the SIP technique.

Conventionally, when a plurality of chips are stacked vertically, a liquid epoxy type adhesive is spread on a die attaching area, a semiconductor chip is mounted, and then the chip may be fixed at a desired position by curing.

In other words, before attaching the semiconductor chips, the liquid epoxy is provided to a package substrate or a surface of a lower semiconductor chip, for example, by a dispensing method. Subsequently, the semiconductor chip is mounted on the epoxy and mechanically fixed on the package substrate or the lower semiconductor chip through a subsequent curing process.

However, when the epoxy is spread on the die attaching area by dispensing, the adhesive may not be uniformly applied due to a difficulty in controlling the flow of the adhesive and a bleeding phenomenon may occur because the adhesive is liquid.

When the adhesive is bleeding, the surface of the semiconductor chip may be covered with the adhesive and the semiconductor chip may slant, thereby causing a problem in a subsequent packaging process, such as wire bonding. In addition, after encapsulation, when a package is under high temperature, the package may crack due to volatile elements vaporizing from the bled adhesive.

Recently, die stacking packages have been manufactured by a method of stacking and attaching a semiconductor chip to a package substrate or a lower chip using adhesive tape instead of a liquid epoxy adhesive. In this technology, the semiconductor chip is mounted on the die attaching area using the adhesive tape and fixed at a desired position through a curing process.

That is, after the semiconductor chip which has a back surface having an adhesive tape attached thereto is mounted on the die attaching area of the package substrate or on the lower chip, the semiconductor chip may be pre-attached to the substrate or the lower chip by heating the package substrate or the lower chip. After that, the semiconductor chip may be mechanically fixed at a desired position through a subsequent curing process.

As described above, the back surface of the chip refers to a part on which a semiconductor circuit is not formed (versus a front surface thereof on which a semiconductor circuit is located). The chip may be mounted such that the tape on the back surface can be located on the package substrate or the lower chip.

As described above, when the die stacking package is manufactured using adhesive tape, the possibility of degradation may be reduced which occurs in applying a conventional liquid epoxy adhesive. However, other problems may occur in the process of attaching the semiconductor chip to the die attaching area of the package substrate or the surface of the lower chip due to characteristics of the adhesive tape.

For example, in order to pre-attach a semiconductor chip to the die attaching area of a package substrate or a lower chip, it may be necessary to heat the package substrate or the lower chip above a desired temperature. The heating temperature is a temperature for pre-curing the adhesive tape which is attached to the back surface of the chip, and it may be about 175 to 250° C. However, when the process for attaching the semiconductor chip is performed at the higher temperature, warpage may occur because the package substrate or the lower chip may not be able to endure such a high temperature. Once warpage occurs in the package or the lower chip, it is difficult to attach the semiconductor chip and also difficult to proceed to a subsequent packaging operation, thereby causing frequent degradation and deterioration of the products.

Further, even if the warpage does not occur during operation, the processing time may increase and production by unit per hour (UPH) may decrease because it may take more time to transfer the heat from the package substrate or the lower chip to the adhesive tape.

### SUMMARY OF THE INVENTION

Exemplary embodiments of the present invention provide a die bonding apparatus which may lower the heating temperature applied to a substrate material such as a package substrate or a lower semiconductor chip when bonding a semiconductor chip on the substrate material, to thus reduce or prevent warpage of the substrate material, to reduce degradation and/or to shorten the processing time.

In an exemplary embodiment of the present invention, a die bonding apparatus includes a bond head providing a heating function. The bond head may include a die collet. When bonding a semiconductor chip having an adhesive tape attached thereto, the die collet may heat the semiconductor chip when picking up the chip.

In another exemplary embodiment, the die collet may transmit heat from the bond head to the semiconductor chip.

In another exemplary embodiment, the die collet may provide the heating function.

In another exemplary embodiment, the die collet may be made of ceramic or metal capable of transmitting heat.

In another exemplary embodiment, a pulse heating may be used for heating the semiconductor chip.

In another exemplary embodiment, constant heating may be used for heating the semiconductor chip.

In another exemplary embodiment, linear heating may be used for heating the semiconductor chip.

In another exemplary embodiment, heating defined by any mathematical formula may be used for heating the semiconductor chip.

Another exemplary embodiment of the present invention provides a method of die bonding which includes preparing a wafer having a plurality of semiconductor chips, each having an adhesive tape attached thereto, picking up each semiconductor chip using a die collet and heating the semiconductor chip using the die collet, moving and mounting the chip on a substrate material. In another exemplary embodiment, the semiconductor chip may also be heated by heat transmitted through the substrate material.

### BRIEF DESCRIPTION OF THE DRAWINGS

The present invention will be more readily apparent from the description of the exemplary embodiments that follows, with reference to the attached drawings in which:

FIG. 1 is a flow chart illustrating a process of bonding a semiconductor chip according to an exemplary embodiment of the present invention;

FIGS. 2a to 2g are views illustrating exemplary portions described in the flow chart of FIG. 1.

FIG. 3 is a block diagram illustrating a general structure of a die bonding apparatus according to an exemplary embodiment of the present invention.

FIG. 4a is a graph of temperature versus time for pulse heating according to an exemplary embodiment of the present invention.

FIG. 4b is a graph of temperature versus time for constant heating according to an exemplary embodiment of the present invention.

FIG. 5 is a block diagram illustrating a bond head having a heating function according to an exemplary embodiment of the present invention.

FIG. 6 is a block diagram illustrating a bond head having a heating function according to an exemplary embodiment of the present invention.

### DETAILED DESCRIPTION OF EXEMPLARY EMBODIMENTS OF THE INVENTION

Reference will now be made in detail to exemplary embodiments of the present invention, which are illustrated in the accompanying drawings. In the following description, the same drawing reference numerals are used for the same elements even in different drawing.

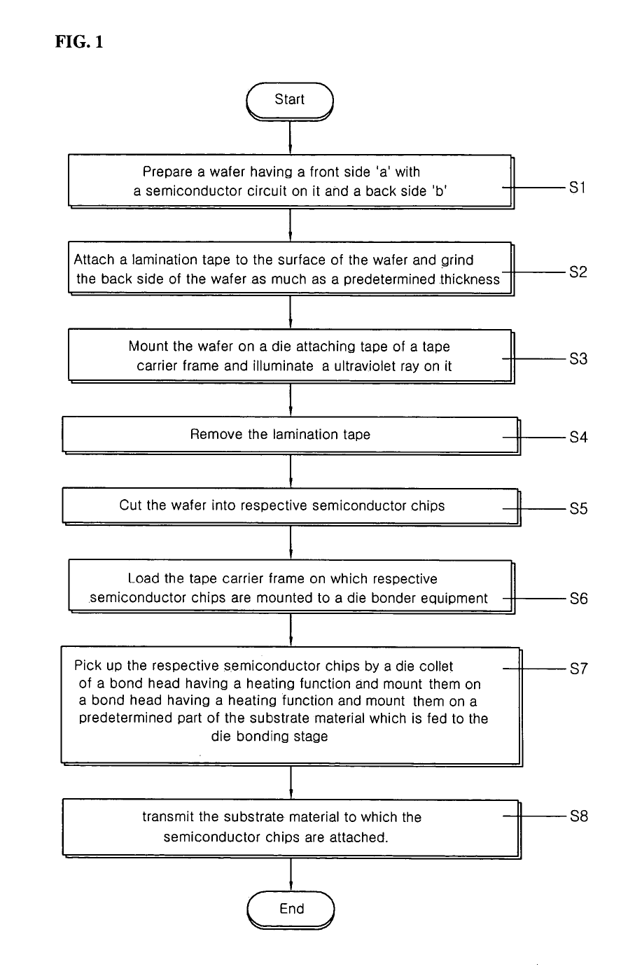

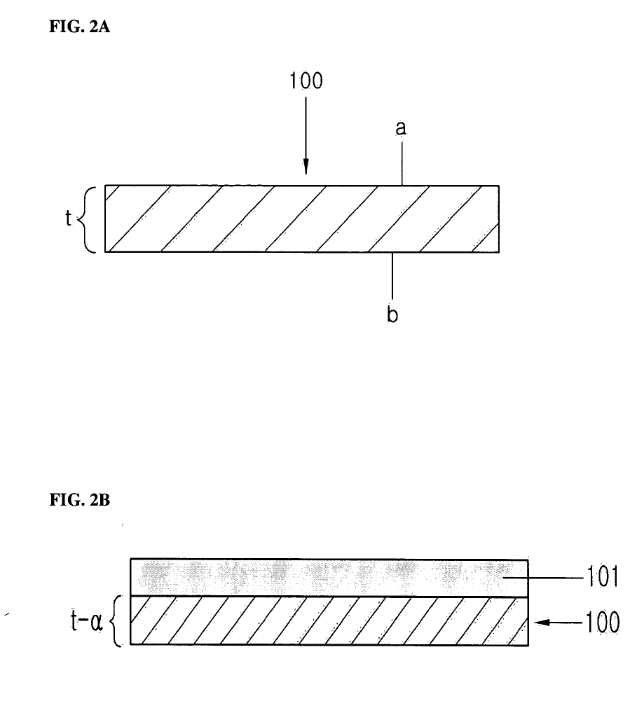

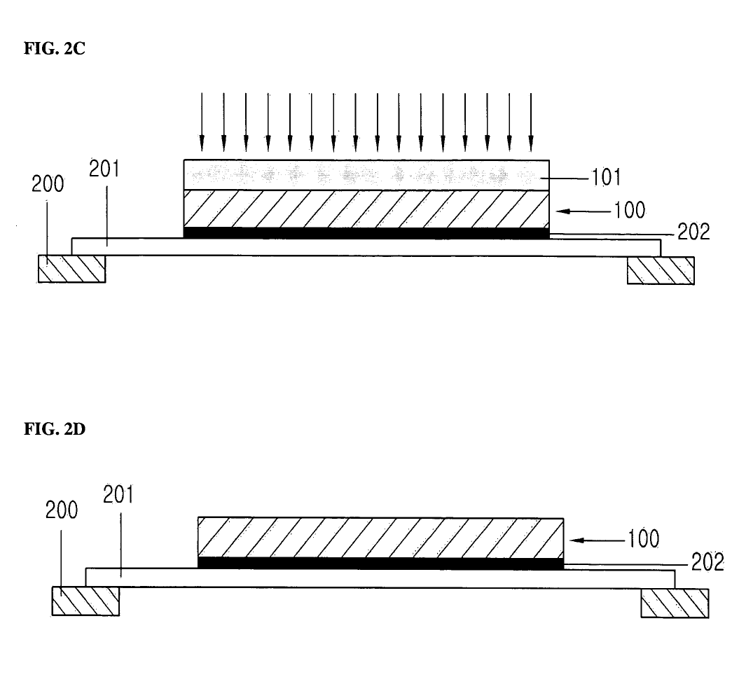

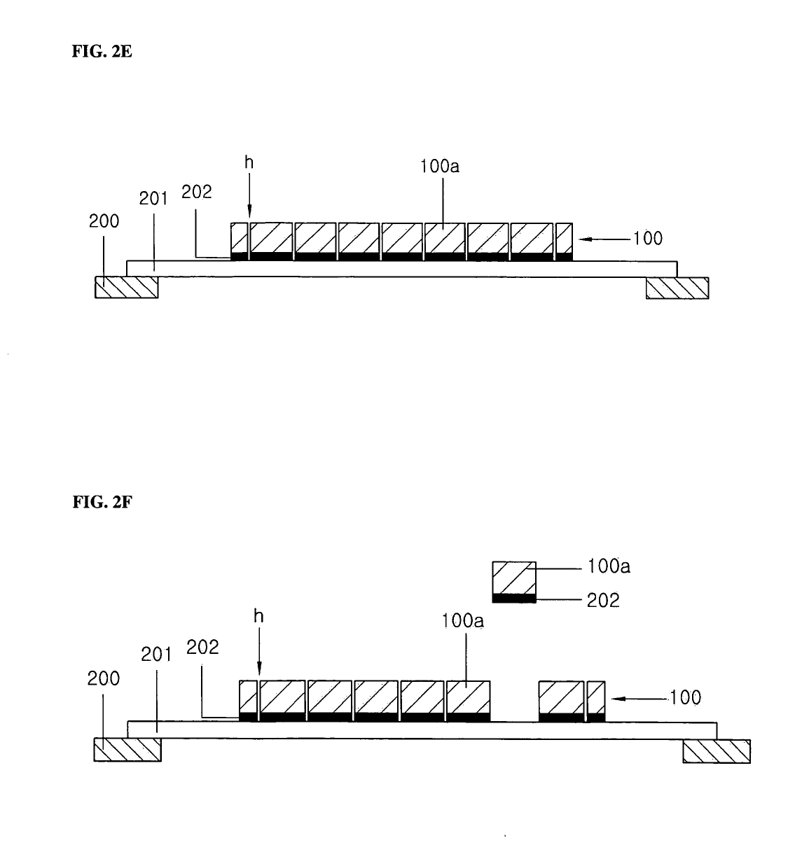

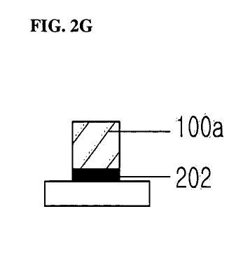

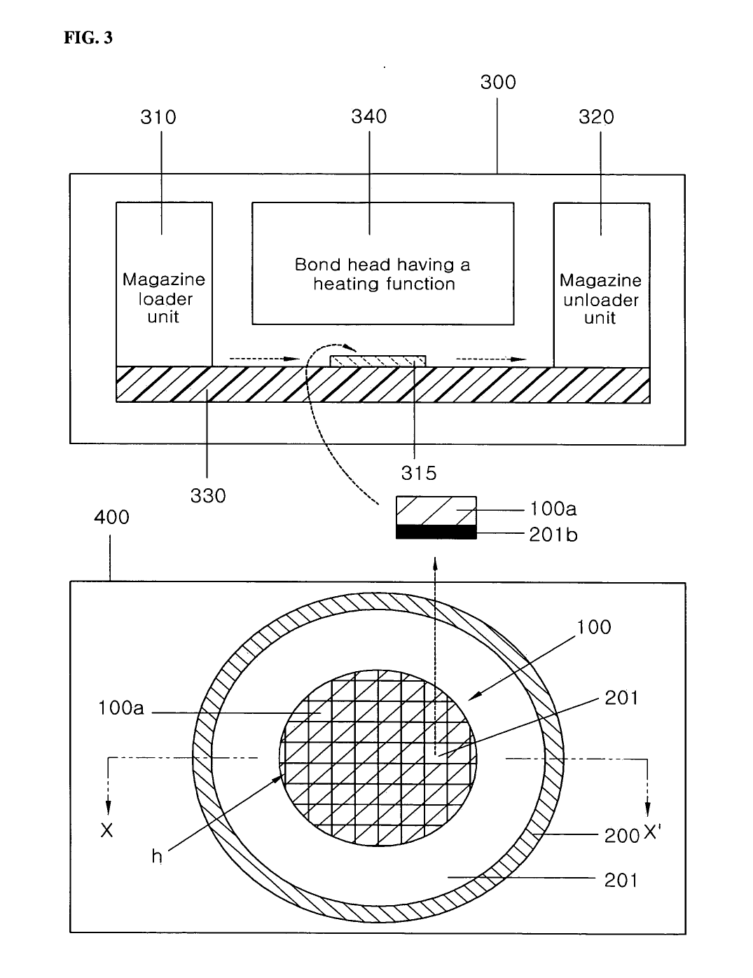

FIG. 1 is a flow chart illustrating a process of bonding a semiconductor chip according to exemplary embodiments of the present invention, FIGS. 2a to 2g are views illustrating exemplary portions of the flow chart in FIG. 1, and FIG. 3 is a block diagram illustrating a general structure of a die bonding apparatus according to an exemplary embodiment of the present invention.

With reference to FIGS. 1, 2a-2g, and 3, the process of bonding a chip according to exemplary embodiments of the present invention is explained. As shown in FIG. 2a, a wafer 100 with the thickness of ‘t’ is prepared, which has a front surface ‘a’ on which a plurality of semiconductor circuits may be formed and a back surface ‘b’ on which a plurality of semiconductor circuits are not formed (S1 in FIG. 1).

Tape, such as a lamination tape 101 may be attached to the surface ‘a’ of the wafer 100, as shown in FIG. 2b, and the wafer 100 may be fabricated to have the thickness of t-α by grinding (for example, the back surface) to a desired thickness, i.e., a (S2 in FIG. 1). The lamination tape may be optional as would be known to one of ordinary skill in the art. The grinding process may be optional as would be known to one of ordinary skill in the art.

As shown in FIG. 2c, the wafer 100 which may be fabricated to have a desired thickness may be mounted on tape, for example, a die attaching tape 202 and on another tape, for example a wafer mounting tape 201 which may supported by a tape carrier frame 200 in a way that the die attaching tape 202 is attached to the back surface of the wafer 100. The die attaching tape and/or the wafer mounting tape may be optional as would be known to one of ordinary skill in the art. Other tape or more tape layers could also be used as would be known to one of ordinary skill in the art.

In an exemplary embodiment, an ultraviolet (UV) ray may be illuminated on the lamination tape 101 in the direction of the arrows. The adhesive strength decreases when a UV ray is illuminated on the lamination tape 101, whereby the lamination tape 101 may be separated from the semiconductor chip (S3 in FIG. 1). In other exemplary embodiments, other wavelength radiation may be used, such as an infrared radiation, as would be known to one of ordinary skill in the art.

The lamination tape 101 may be removed, as shown in FIG. 2d (S4 in FIG. 1).

Thereafter, the wafer 100 may be cut into a plurality of semiconductor chips 100a by, for example, dicing with a cutter unit, such as a blade. The die attaching tape 202 may also be cut by the blade together with the wafer 100. When completing the cutting process, a plurality of grooves h may be formed between the adjacent semiconductor chips, as shown in FIG. 2e (S5 in FIG. 1).

After the cutting process, the tape carrier frame 200 on which the plurality of semiconductor chips 100a are mounted may be loaded onto a wafer handling system 400 of a die bonding apparatus, as shown in FIG. 3. For easier understanding of the subsequent process, FIG. 3 is a cross-sectional view illustrating the loaded state of chips from FIG. 2e (S6 in FIG. 1).

Referring to FIG. 3, the die bonding apparatus according to exemplary embodiments of the present invention may include a substrate material handling system 300 and a wafer handling system 400.

The substrate material handling system 300 may include a magazine loader unit 310 which loads a substrate material such as a package substrate or a lower chip, a feeding unit 330 which feeds the substrate material supplied from the magazine loader unit 310, a bond head 340 with a die collet which acts as a chip transmission unit, and a magazine unloader unit 320 which unloads a substrate material to which the chip is attached.

In an exemplary embodiment, the bond head 340 provides a heating function and the die collet which is attached to the bond head 340 may be formed of a thermally conductive material, such as a ceramic or a metal, capable of transmitting heat.

Accordingly, the semiconductor chip is transmitted in the following way. When a substrate material 315 is supplied to the feeding unit 330 from the magazine loader unit 310, the surface of the semiconductor chip 100a to which the die attaching tape 202 is attached is picked up using a die collet and the semiconductor chip 100a is mounted at a desired position on the substrate material 315 which is fed to the die bonding stage of the feeding unit 330.

It may be possible to heat the semiconductor chip 100a when it is picked up by the die collet, by a heating function of the bond head 340 and a die collet formed of a thermally conductive material. It may be possible to heat the semiconductor chip 100a with a die collet providing a heating function.

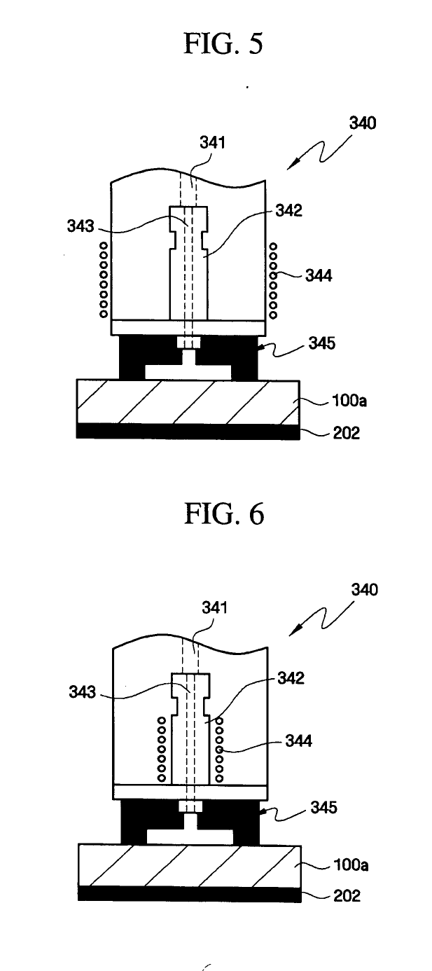

FIG. 5 is a block diagram illustrating a bond head having a heating function according to exemplary embodiments of the present invention. As illustrated, the bond head 340 may be coupled to a die collet 345 at a lower part thereof. The bond head 340 may be connected to an external vacuum pump (not shown), with which a die is picked up by vacuum lifting and transferred to a desired position on a substrate material 315 of a bonding stage, thereby performing a chip transfer. The bond head 340 may be equipped with a vacuum path 341 connected to the external vacuum pump, and the vacuum path 341 may be connected to a vacuum hole 343 of a collet holder 342 coupled to the lower part of the die collet 345 so as to allow the die collet 345 to vacuum-lift the die 100a. The bond head 340 may also be equipped with a heating coil 344 so as to implement the heating function.

In exemplary embodiments, the die collet 345 may be detachably coupled from the collet holder 342 at a lower part of the bond head 340, or otherwise may be fixedly coupled to the bond head 340. The die collet 345 may be made of such materials as metals having a higher heat conductivity.

The die 100a may be transferred to a desired position on a substrate material 315 according to an operation of the bond head 340 as it is vacuum-lifted and attached to the bottom face of the die collet 345. Heat generated from the heating coil 344 of the bond head 340 may be conducted to the die collet 345 and subsequently to the die 100a, and heat is supplied to the tape 202 mounted on the wafer 100. The heating coil 344 may be wound along an the outer circumference of the bond head 340. The heating coil 344 may generate heat from electric signals supplied from an external power supply device.

As an another exemplary embodiment illustrated in FIG. 6, the heating coil 344 may be constructed to be wound along an outer circumference of the collet holder 342 inside the bond head 340.

Heating may be performed when picking up the semiconductor chip through a pulse heating method or a constant heating method. In other exemplary embodiments, the other heating methods, such as exponential heating, linear heating, or heating according to any other mathematical formula, may be used as would be known to one of ordinary skill in the art.

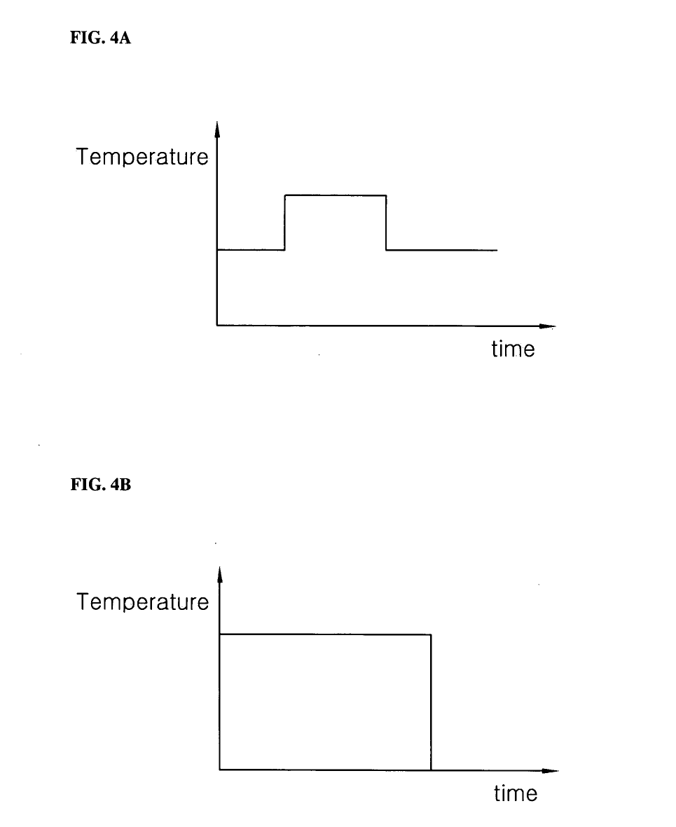

FIG. 4a is a example graph illustrating temperature versus time for pulse heating, and FIG. 4b is a example graph illustrating temperature versus time for constant heating.

As shown in FIG. 4a, pulse heating is performed by heating the chip at a relatively low temperature in an early stage and then raising the temperature, while constant heating is performed by maintaining a given level of temperature set at an early stage.

The semiconductor chip 100a may be picked up by a die collet of a bond head and mounted on a given part on the substrate material 315 which is fed to the die bonding stage. After that, the semiconductor chip 100a is placed on the substrate material 315 by applying a given force for a given time. At this time, the respective semiconductor chip 100a is carried as in the state that the die attaching tape 202 is attached to its back surface, as shown in FIG. 2f. FIG. 2f illustrates the section X-X′ of FIG. 3 and the block diagram of FIG. 3 illustrate a series of process flows involved (S7 in FIG. 1).

The substrate material 315 may be heated to a given temperature and the semiconductor chips 100a may be attached to the substrate material 315 using heat transmitted through the heated substrate material 315 and/or heat transmitted to the semiconductor chip 100a through the die collet. After that, the substrate material to which the semiconductor chip 100a is attached is transmitted to the magazine unloader unit 320 of FIG. 3, thereby completing the process, as shown in FIG. 2g (S8 in FIG. 1).

As a varied embodiment of the present invention, after the chip 100a is attached to the substrate material 315, a post cure may optionally be performed in an oven so as to increase adhesiveness of the tape.

Furthermore, although the addition of the heating function to the bond head has been described by way of example, it may be possible to provide a heating function to the die collet instead of the bond head or both the bond head and the die collet.

An exemplary embodiment of the present invention has described heating both the substrate material 315 and the semiconductor chip 100a at the same time. However, it may be possible to only heat the chip by the die collet without heating the substrate material.

As desired, when the chip 100a to which the die attaching tape 202 is attached is picked up by the die collet and mounted on the substrate material, the chip 100a is heated at the same time as the chip is picked up. As a result, the semiconductor chip 100a is heated by the substrate material 315 and also by the die collet.

Accordingly, it may be possible to attach the chip with a lower heating temperature than the temperature used in a conventional die bonding apparatus after mounting the chip or without applying heat to the substrate material.

Consequently, the occurrence of warpage of the substrate material may be prevented or reduced. Also, as the time taken when the heat of the substrate material is transmitted to the die attaching tape may be reduced, the processing time may decrease and the output per unit time may increase.

The exemplary embodiments of the present invention have been described in an illustrative manner, and it is to be understood that the terminology used is intended to be in the nature of description rather than of limitation. Many modifications and variations of the exemplary embodiments of the present invention are possible in light of the above teachings. Therefore, it is to be understood that within the scope of the appended claims, the exemplary embodiments of the present invention may be practiced otherwise than as specifically described above.

1. A die bonding apparatus comprising:
a loading unit for loading a substrate;
a feeding unit for feeding the substrate to a bonding stage;
a bond head for moving and mounting a semiconductor chip having an adhesive tape attached thereto on a part of the substrate, wherein the bond head has a heating function for heating the semiconductor chip; and
a unloading unit for unloading the substrate to which the semiconductor chip is attached.

2. The apparatus of claim 1, wherein the bond head includes a die collet for picking up and holding the semiconductor chip.

3. The apparatus of claim 2, wherein the die collet transmits heat from the bond head to the semiconductor chip.

4. The apparatus of claim 3, wherein the die collet is made of ceramic capable of transmitting heat.

5. The apparatus of claim 3, wherein the die collet is made of metal capable of transmitting heat.

6. The apparatus of claim 2, wherein the die collet provides the heating function for heating the semiconductor chip.

7. The apparatus of claim 6, wherein the die collet is made of ceramic capable of transmitting heat.

8. The apparatus of claim 6, wherein the die collet is made of metal capable of transmitting heat.

9. The apparatus of claim 1, wherein the bond head heats the semiconductor chip using pulse heating.

10. The apparatus of claim 1, wherein the bond head heats the semiconductor chip using constant heating.

11. The apparatus of claim 1, wherein the bond head heats the semiconductor chip using linear heating.

12. The apparatus of claim 1, further comprising a wafer holding unit for holding a wafer having a plurality of semiconductor chips having a plurality of adhesive tapes attached thereto.

13. The apparatus of claim 1, wherein the substrate is a package substrate.

14. The apparatus of claim 1, wherein the substrate is a lower semiconductor chip.

15. The apparatus of claim 1, wherein the substrate provides the heating function for heating the semiconductor chip.

16. A method of die bonding, comprising:
preparing a wafer having a plurality of semiconductor chips in a die bonding apparatus, each having a back surface attached with an adhesive tape;
heating the plurality of semiconductor chips using a bond head;
moving and mounting each semiconductor chip on a part of a substrate using the bond head; and
bonding the each semiconductor chip to the substrate.

17. The method of claim 16, wherein preparing the plurality of semiconductor chips includes:
preparing the wafer having a front surface with semiconductor circuits formed thereon and a back surface without semiconductor circuits formed thereon;
mounting the wafer on an adhesive tape located on a tape carrier frame; and
dicing the wafer into the plurality of semiconductor chips such that the adhesive tape is cut into a plurality of die bonding tapes.

18. The method of claim 17, further comprising:
attaching a lamination tape to a front surface of the wafer;
grinding the back surface of the wafer to a desired thickness;
supplying a radiation to the lamination tape; and
separating the lamination tape from the front surface of the wafer before dicing the wafer.

19. The method of claim 16, wherein the moving and mounting each semiconductor chip includes:
picking up each semiconductor chip using a die collet of the bond head; and
heating the one semiconductor chip when picking up each semiconductor chip.

20. The method of claim 19, wherein the die collet transmits heat from the bond head for heating each semiconductor chip.

21. The method of claim 19, wherein the die collet provides the heating function for heating each semiconductor chip.

22. The method of claim 19, wherein each semiconductor chip is heated using constant heating.

23. The method of claim 19, wherein each semiconductor chip is heated using pulse heating.

24. The method of claim 16, further comprising performing a post cure after bonding each semiconductor chip to the substrate.

25. The method of claim 16, further comprising heating the substrate material when bonding each semiconductor chip to the substrate material.

26. A bond head comprising:
a portion for moving and mounting a semiconductor chip having an adhesive tape attached thereto on a part of the substrate; and
a heater unit for heating the semiconductor chip.

27. The bond head of claim 26, further comprising a die collet for picking up and holding the semiconductor chip.

28. The bond head of claim 27, wherein the die collet transmits heat from the bond head to the semiconductor chip.

29. A die collet comprising:
a portion for picking up and holding a semiconductor chip; and
a heater unit for heating the semiconductor chip.
